(19) United States
(12) Patent Application Publication
(10) Pub. No.: US 2006/0125706 A1
(43) Pub. Date: Jun. 15, 2006

(54) High performance multimode horn for communications and tracking

(76) Inventors: Eric Amyotte, Laval (CA); Yves Demers, Montreal (CA); Santiago Sierra-Garcia, Montreal (CA); Jaroslaw M. Uher, Pointe-Claire (CA)

Correspondence Address: Franz Bonsang;c/o PROTECTIONS EQUINOX INT'L INC., Suite 224, 4480, Cote-de-Liesse, Montreal, QC, H4N 2R1, CA

(21) Appl. No.: 11/302,339

(22) Filed: Dec. 14, 2005

Related U.S. Application Data
(60) Provisional application No. 60/635,474, filed on Dec. 14, 2004.

(51) Int. Cl. H01Q 13/00

(52) U.S. Cl. 343/786

(57) ABSTRACT

A multimode horn used to feed an antenna includes a generally tapered wall for transmitting and/or receiving an electromagnetic signal there through. The wall flares radially outwardly from a throat section to an aperture and defines an internal surface having a plurality of discontinuities. The geometry of the discontinuities are configured and sized to alter the dominant mode, which conveys the communications signal, into a higher order symmetrical mode content to achieve a balance between a plurality of communications performance parameters of the antenna over a pre-determined frequency range of the signal. The discontinuities are also designed to match the horn impedance for the modes of the communications signal and for an asymmetrical mode content of a simultaneously propagating tracking signal.

### CROSS-REFERENCE TO RELATED APPLICATION

Priority of U.S. Provisional Application No. 60/635,474, filed on Dec. 14, 2004, is hereby claimed.

### FIELD OF THE INVENTION

The present invention relates to a horn for use in RF signal transmitters and/or receivers, and more particularly to a multimode communications and tracking horn having symmetrical higher order modes generated through discontinuities such as corrugations, smooth profiles, chokes and/or steps, while efficiently propagating chosen asymmetrical tracking modes. BACKGROUND OF THE INVENTION

Modern broadband high capacity satellite communication systems give rise to a host of challenging antenna design problems. High-gain Multi-Beam Antennas (MBAs) are probably the best example of such challenging antenna designs. The MBAs typically provide service to an area made up of multiple contiguous coverage cells. The current context assumes that the antenna configuration is of the focal-fed type, as opposed to an imaging reflector configuration or a direct radiating array. It is also assumed that each beam is generated by a single feed element and that the aperture size is constrained by the presence of adjacent feed elements generating other beams in the contiguous lattice.

Impact of Feed Performance on MBA Performance

It is well known that in order to achieve an optimal reflector or lens antenna performance, the reflector illumination, including edge-taper, needs to be controlled. FIG. 1 illustrates the EOC (Edge Of Coverage) gain of a typical MBA as a function of reflector illumination taper, assuming a cos^{q}-type illumination. The first-sidelobe level is also shown, on the secondary axis. Depending on sidelobe requirements, FIG. 1 shows that a reflector edge-taper of 12 to 13 dB (decibels) is close to optimal. A slightly higher illumination edge-taper will yield a better sidelobe performance with a minor degradation in gain.

In multiple beam coverages, ensuring an adequate overlap between adjacent beams, typically 3 or 4 dB below peak, requires close beam spacing. In such applications where reflector or lens antennas are used and where each beam is generated with a single feed element, this close beam spacing leads to a feed array composed of tightly clustered small horns. The performance of such antennas is limited by the ability to efficiently illuminate the antenna aperture with small, closely-packed feed elements producing a relatively broad primary pattern. The main factors limiting antenna performance include:
1-High antenna spill-over losses, degrading gain performance; and
2-Limited edge illumination taper, leading to relatively high sidelobe levels.

Multiple reflectors generating sets of interleaved alternate beams have been proposed as a mean of alleviating the performance limitations described above. By using multiple apertures, the feed elements are distributed, hence the spacing and size of elements on a given feed array can be increased, resulting in a narrower, more directive, primary pattern for each feed element. The element size approximately increases as the square root of the number of apertures used. For example, interleaving the beams produced by four reflectors, as shown in FIG. 2, yields an element whose size is increased by a factor of about two (2). This greatly reduces spill-over losses and consequently improves the co-polarized sidelobe levels. The four different beam labels, identified by letters A, B, C & D in FIG. 2, refer to beams generated by the four apertures having corresponding designations.

Although multiple apertures significantly improve antenna performance by increasing the physical element size, it can be easily demonstrated that even with four apertures, the performance of MBAs employing a single feed element per beam is still limited by the aperture efficiency η of the feed element defined as:
η=g*(λ/πd)²
where g is the peak gain, or directivity, λ is the lowest wavelength of the signal operating frequency band and d is the physical diameter of the feed element, or feed spacing.

Assuming a cos^{q}-type feed pattern, it can be derived that the illumination edge-taper (ET) of a four-reflector system is:
ET(dB)≈13*η
where η is the feed aperture efficiency. This means that for a four-reflector system, feed elements with at least 92% aperture efficiency are needed in order to achieve the 12 dB illumination taper, identified as optimal in FIG. 1. Achieving a higher edge-taper, for better sidelobe control, necessitates even higher feed aperture efficiency.

Similarly, we find that if three reflectors are used instead of four, the reflector illumination edge taper can be approximated as:
ET(dB)≈9.75* η

In reality, the relationship between ET and η is not exactly linear. A more rigorous analysis shows that as the edge-taper increases, the reflector size also needs to be increased in order to maintain the same beamwidth. This increase in reflector size results in a second-order increase in reflector edge-taper.

As illustrated in FIG. 3, a parametric analysis shows that the MBA gain is optimal for a feed aperture efficiency of about 95%. Selection of another beam crossover level would affect the location of the optimal point, but in general the optimal feed efficiency will always be between 85% and 100%.

Conventional Solutions

It has been established that high aperture efficiency elements are required to maximize the performance of MBAs. Although conical horns offer reasonable aperture efficiency (typically between 80% and 83%), they suffer from bad pattern symmetry and poor cross-polar performance. Dual-mode or hybrid mode horns have been developed to ensure excellent pattern symmetry and cross-polar performance. Conventional dual-mode horns include the well-known Potter horn and hybrid multimode horns are usually of the corrugated type, as illustrated in FIGS. 4 and 5 respectively.

Potter horns typically offer 65-72% efficiency, depending on the size and operating bandwidth. Corrugated horns can operate over a wider band but yield an even lower efficiency, due to the presence of the aperture corrugations that limit their electrical diameter to about λ/2 less than their physical dimension.

Consequently, as shown in FIG. 3, conventional dual-mode or hybrid mode feedhorns do not allow to achieve an optimal MBA performance, since insufficient reflector edge-taper results in high sidelobe levels and a gain degraded by high spill-over losses.

U.S. Pat. No. 6,396,453 granted to E. Amyotte et al. on May 28, 2002, discloses a high performance multimode horn having a plurality of discontinuities, including steps, corrugations, smooth profiles and/or chokes, on its internal surface that are configured and sized to alter the higher order mode content of the communications signal that propagates there through.

Impact of Pointing Error on Antenna Performance

The very high gain required in multi-beam, broadband antenna systems result in very narrow pencil beams. Consequently, it is crucial to maintain an accurate antenna pointing in order to achieve an optimal antenna performance. Especially for spacecraft mounted antennas, antenna pointing is affected by several factors, including long-term effects and diurnal effects such as those caused by the thermal environment. For spacecraft antennas, the typical pointing error is in the range ±0.12° to ±0.15° .

For example, if we assume that the nominal gain at the edge of a cell is 4 dB below the beam peak, a pointing error of ±0.12° (typical for non-tracking antennas) would lead to significant edge-of-cell (EOC) gain degradations, as illustrated in FIG. 6 for various cell sizes.

As a consequence, many of these communications antennas require a closed-loop tracking system to minimize the performance degradation due to pointing error. With this approach, RF sensors provide beam pointing information by using a reference ground beacon, and the reflectors are steered such as to compensate the measured pointing error. With RF tracking the antenna pointing error is typically reduced in the range of±0.02° to ±0.05° . As can be seen in FIG. 6 a pointing error of this magnitude is far less damaging to the EOC gain performance.

In most spacecraft systems the RF tracking is done by measuring the RF signal coming from a beacon located on the Earth, or any other incoming signal. This beacon is generally located inside the antenna coverage zone for best performance and for cost/implementation considerations. As a result, the tracking feed has to be located inside the multibeam antenna feed cluster. In many instances it is not possible to use a dedicated feed or feed cluster for antenna RF tracking purposes. There is simply not enough room in between the communications feeds to fit the tracking feed even if the coverage zone is produced with multiple reflectors to increase the feed separation in the feed block. In these cases, a multimode (also referred to as overmode) tracking feed combining the communications and RF Sensing functionality must be used.

An overmode feed can be successfully implemented with a single feed aperture to yield the monopulse sum and difference signals needed for a RF tracking system. The concept is based on the use of asymmetric modes in addition to the typical high-performance symmetric mode mix used for the communication signal. Such tracking modes could include the TE₂₁ and TM₀₁ modes for circular apertures.

The offset of the antenna boresight from the earth station beacon, or target-tracking error, excites asymmetrical modes in the feed. These modes can be used in conjunction with the symmetric modes to produce the sum and difference-signals needed for computing the two-axis angular errors (azimuth and elevation). The tracking asymmetric mode contents are not typically altered by symmetrical discontinuities in the feed horn, which may be use to enhance the performance for the communications signals. There is however a significant technical challenge in matching the impedance of the multimode horn for the communications signals and the asymmetrical tracking modes over the specified frequency band(s). Existing tracking feed chains can not support high efficiency multimode communications signals such as those described above.

Using a specially designed mode extractor, the “tracking” modes can be extracted from the overmode tracking and communications feed horn, without altering the communications signals, such as to provide information that can be used to repoint the antennas thus greatly improving the antenna performance.

Accordingly, there is a need for a high performance multimode horn that can simultaneously propagate an asymmetrical mode content of a “tracking”signal and provide an optimal symmetrical mode conversion of the communications signal.

### SUMMARY OF THE INVENTION

It is therefore a general object of the invention to provide an improved multimode horn that obviates the above noted disadvantages.

An advantage of the present invention is that the multimode horn has a series of discontinuities that are designed to simultaneously propagate higher order symmetrical modes for a communications signal transmitted and/or received there through and asymmetrical tracking modes that can be used to track an incoming signal, a radio-frequency beacon tracking signal or the like by allowing the propagation of one or more tracking modes.

Another advantage of the present invention is that the multimode horn alters the symmetrical mode content of the communications signal and allow the propagation of asymmetrical mode content of the tracking signal transmitted and/or received there through via regular and/or irregular corrugation, smooth profile, choke and/or step discontinuities.

A further advantage of the present invention is that the multimode horn efficiently propagates an asymmetrical tracking mode content that can be used to track an incoming signal.

Another advantage of the present invention is that the multimode horn feeding an antenna is tailored relative to a plurality of performance parameters including at least one of the following: horn on-axis directivity, horn pattern beamwidth, antenna illumination edge-taper, antenna illumination profile, antenna spill-over losses and tracking mode return loss.

Still a further advantage of the present invention is that the multimode communications and tracking horn, when coupled to the appropriate mode extractor, is able to detect the location of an incoming signal, such as a ground beacon or the like, using a higher order asymmetrical mode content while providing an optimal gain for the communications signals over the same geographical location.

Other objects and advantages of the present invention will become apparent from a careful reading of the detailed description provided herein, with appropriate reference to the accompanying drawings.

According to one aspect of the present invention, there is provided a multimode horn for communications and tracking for transmitting and/or receiving an electromagnetic communications signal and for feeding an antenna, said horn comprising a generally tapered wall flaring radially outwardly from a throat section to an aperture thereof, said wall defining an internal surface having a plurality of discontinuities, the geometry of said discontinuities being configured and sized for altering the higher order symmetrical mode content of the communications signal so as to achieve a balance between a plurality of performance parameters of the antenna over a pre-determined frequency range of the communications signal, said discontinuities matching an impedance of said horn for said communications signal and an asymmetrical mode content of a tracking signal simultaneously propagating therethrough.

Typically, the wall has a circular, square or hexagonal cross-section shape.

In one embodiment, the tracking signal is the communications signal or a different signal that could be in a tracking frequency range different than the pre-determined communication frequency range.

In one embodiment, the discontinuities for matching the horn impedance for the communications signal and the tracking signal are located within a matching section of said wall.

Typically, the matching section is located adjacent to the throat section.

Conveniently, the discontinuities of the matching section include a combination of different local smooth profiles, steps, corrugations, dielectric inserts and/or chokes.

In one embodiment, the discontinuities are formed on said surface.

In one embodiment, the geometry of said discontinuities of the matching section is configured and sized for allowing propagation of the asymmetrical tracking mode content and the symmetrical communication mode content within the pre-determined frequency range.

Typically, the asymmetrical tracking mode content includes at least one of TE₂, and TM₀₁.modes

In one embodiment, the discontinuities are generally axially symmetrical around a generally central axis of said wall.

In one embodiment, the plurality of performance parameters includes tracking mode return loss and at least one of the group -consisting of horn on-axis directivity, antenna illumination edge-taper, antenna illumination profile, and antenna spill-over losses.

### BRIEF DESCRIPTION OF THE DRAWINGS

In the annexed drawings, like reference characters indicate like elements throughout.

FIG. 1 is a graphical illustration of a typical multibeam antenna (MBA) performance as a function of the reflector (or lens) egde-taper;

FIG. 2 is a graphical illustration of a typical multibeam antenna coverage of a four aperture antenna;

FIG. 3 is a graphical illustration of a typical four aperture multibeam antenna (MBA) performance as a function of the feed efficiency;

FIGS. 4 and 5 are section views of a conventional dual-mode horn and a corrugated horn respectively;

FIG. 6 is a graphical illustration of the effect of pointing error on the edge-of-cell gain of an antenna;

FIG. 7 is a graphical illustration of a comparison of the primary pattern between a typical dual-mode horn and a high performance multimode horn (HPMH); and

FIGS. 8, 9 and 10 are section views of three different embodiments of a HPMH for communications and tracking according to the present invention, showing a narrow band and two dual-band HPMHs respectively.

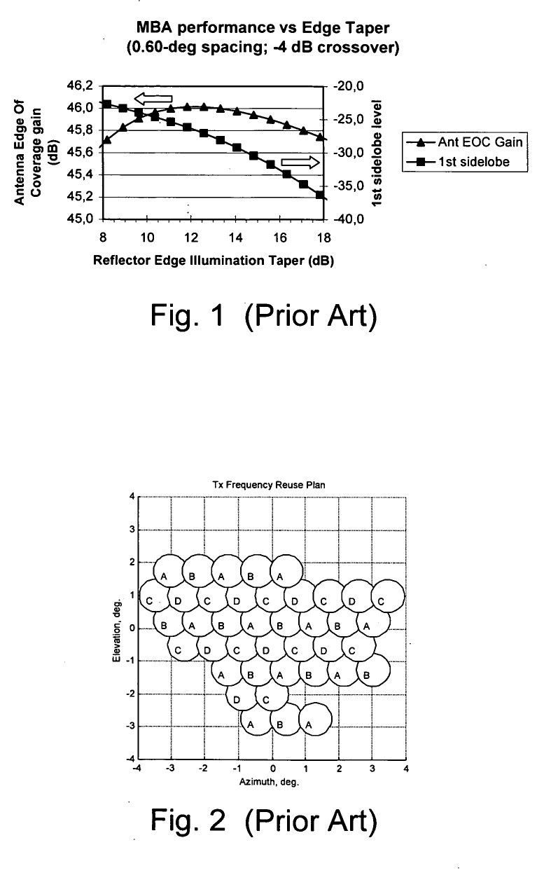

### DETAILED DESCRIPTION OF THE PREFERRED EMBODIMENTS

With reference to the annexed drawings the preferred embodiments of the present invention will be herein described for indicative purpose and by no means as of limitation.

High Performance Multimode Horn for Communications and Tracking

In order to overcome the performance limitations obtained with conventional feed elements, we have developed a high performance multimode horn that generates an optimal mode mix for the communications signals and propagates tracking mode signals, which can be used to accurately track a ground beacon and thus greatly reduce the performance degradations caused by pointing error. These high performance multimode horns can be used in single-aperture multibeam antennas or combined with multiple aperture antennas to further improve their RF (Radio Frequency) performance. This feed element can achieve higher aperture efficiency than conventional dual-mode or hybrid multimode solutions, while maintaining good pattern symmetry and cross-polar performance. Typically, it also needs to efficiently simultaneously propagate asymmetrical modes that can be used for tracking purposes.

Single narrow and wide-band as well as multi-band designs are feasible. The basic mechanism by which the performance improvements sought can be achieved relies on the generation, within the feed element, of higher order TE (Transverse Electric) waveguide modes with proper relative amplitudes and phases, while providing a good impedance match to the higher order asymmetrical tracking modes.

Referring to FIGS. 8 to 10, there are shown different embodiments 20, 20a and 20b of high performance multimode horns (HPMHs) for communications and tracking according to the present invention used to improve the overall performance of their respective antenna. Each HPMH 20, 20a, 20b feeding an antenna includes a generally hollow tapered structure or wall 22 for transmitting and/or receiving an electromagnetic signal there through. The structure 22 substantially flares radially outwardly from a throat (or input) section 24 to an aperture 26, generally of a pre-determined size, and defines an internal surface 28 having a plurality of discontinuities 30 typically formed thereon and designed to alter the symmetrical mode content of the communications signal. These discontinuities 30, made out of electrically conductive material, or by introducing dielectric inserts, are optimized in geometry to achieve a preferred balance (or optimization) between a plurality of performance parameters (or requirements) of the antenna over at least one pre-determined frequency range of the signal. When determining the discontinuities 30, at least one performance parameter is selected from the horn on-axis directivity, the horn pattern beamwidth, the antenna illumination edge-taper, the antenna illumination profile and the antenna spill-over losses is preferably considered, in addition to the impedance match for the tracking modes. The structure cross-section can be circular, square, hexagonal, or the like to provide symmetrical mode content of the communications signal. For simplicity, the specific TE and TM modes described herein correspond to those propagating in a circular cross-section.

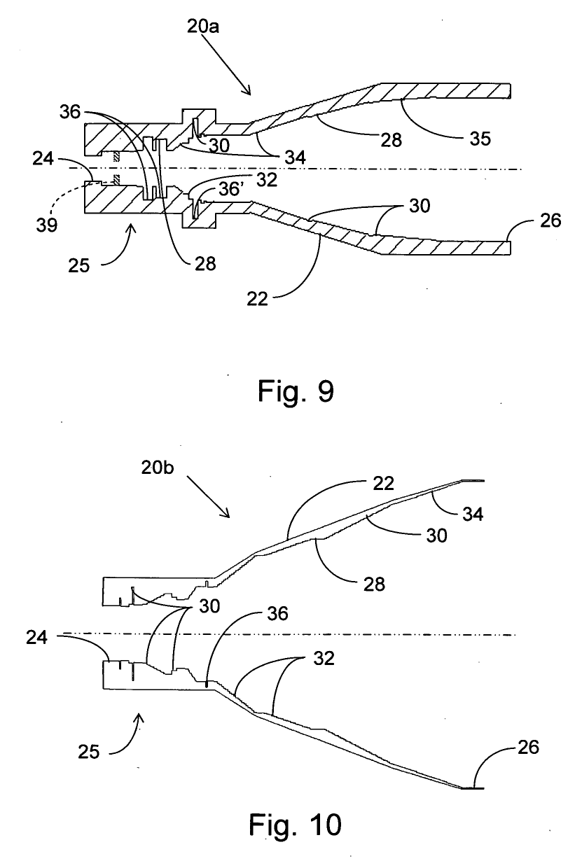

The higher order TE modes are generated in the feed element or horn 22 through a series of adjacent discontinuities 30 including steps 32 and/or smooth profiles 34 and/or corrugations 36 and/or chokes 38 and/or dielectric inserts 39 (such as an iris or the like, as shown in dotted lines in FIG. 9). Smooth profiles 34 located at the aperture 26 are also referred to as changes in flare angle. The optimal modal content depends on the pre-determined size of the aperture 26. Polarization purity and pattern symmetry requirements result in additional constraints for the modal content. The optimal feed horn structure—in terms of discontinuity type 30, quantity, location and dimensions—depends on the optimal modal content and the operating bandwidth. For example, corrugations 36 are typically used for wider operating bandwidth only.

The performance of the multimode feed 20, 20a, 20b of the present invention is therefore tailored, preferably by software because of extensive computation, to a specific set of pattern requirements and RF tracking requirements of a specific corresponding application. For example, it has been found that in order to maximize the peak directivity of a horn 20, 20a, 20b, a substantially uniform field distribution is desired over the aperture 26. In a horn having a circular cross-section, a nearly uniform amplitude and phase aperture field distribution is achieved with a proper combination of higher order TE modes with the dominant TE₁₁ mode. All modes supported by the aperture size are used in the optimal proportion. In fact, a larger aperture 26 supports more modes and provides more degrees of freedom, hence easing the realization of a uniform aperture field distribution. The dominant TE₁₁ mode and the tracking modes, TM₀₁ and TE₂₁ for example, are present at the throat section 24 of the horn 20, 20a, 20b . Using discontinuities 30 of various types, TE₁ₙ modes are generated to enhance the gain. Although modes such as TE₁₂ and TE₁₃ do not have nearly as much on-axis far-field gain parameter contribution as the dominant TE₁₁ mode, a higher composite gain is obtained when these modes are excited with proper amplitudes and phases. In conventional designs of feedhorns 10, 12, these higher order TE modes are usually avoided (with amplitudes near zero) because of their strong cross-polar parameter contribution. The HPMH 20, 20a, 20b, as opposed to conventional horns 10, 12, takes advantage of higher order TE modes. Furthermore, in order to cancel the cross-polar content of these modes, TM₁ₘ (Transverse Magnetic) modes are also generated by the discontinuities 30 in the HPMH 20, 20a, 20b . The TM₁ₘ modes have no on-axis co-polar gain parameter contribution but are used to control cross-polar isolation and pattern symmetry parameters. By accurately controlling the amplitude and phase of the different modes with optimized discontinuities 30, the radiating performance of the HPMH 20, 20a, 20b can be tuned with great flexibility.

Preferably, the feed/antenna performance is tailored to each specific antenna application by using all the modes available as required. The performance parameters to be optimized include, but are not limited to:
Secondary pattern gain;
Secondary pattern sidelobes;
Secondary pattern cross-polar isolation;
Primary pattern peak directivity;
Primary pattern shape;
Primary pattern cross-polar isolation;
Primary pattern symmetry;
Operating frequency band(s);
Illumination edge-taper;
Spill-over loss;
Return loss;
Horn length;
Return loss of tracking asymmetrical mode(s); and
Horn mass.

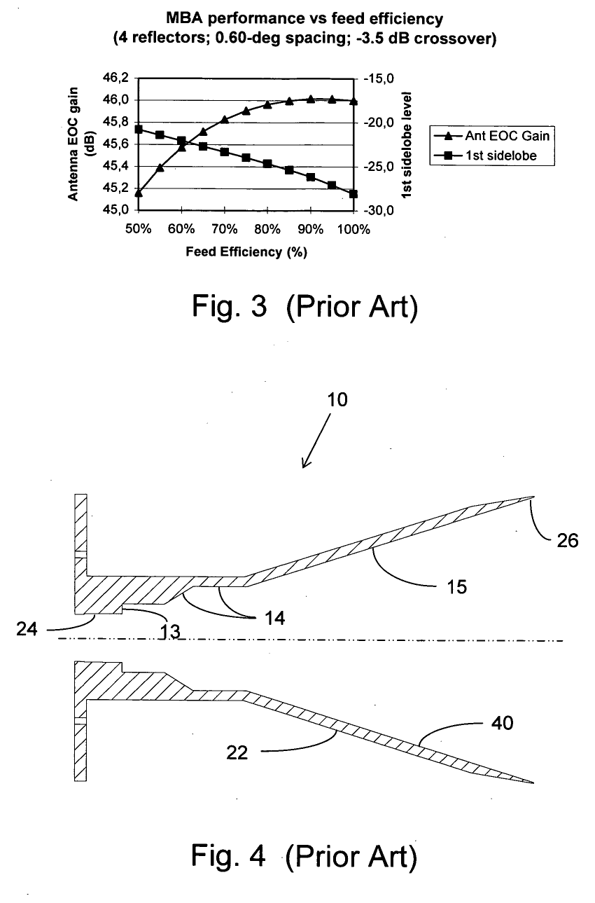

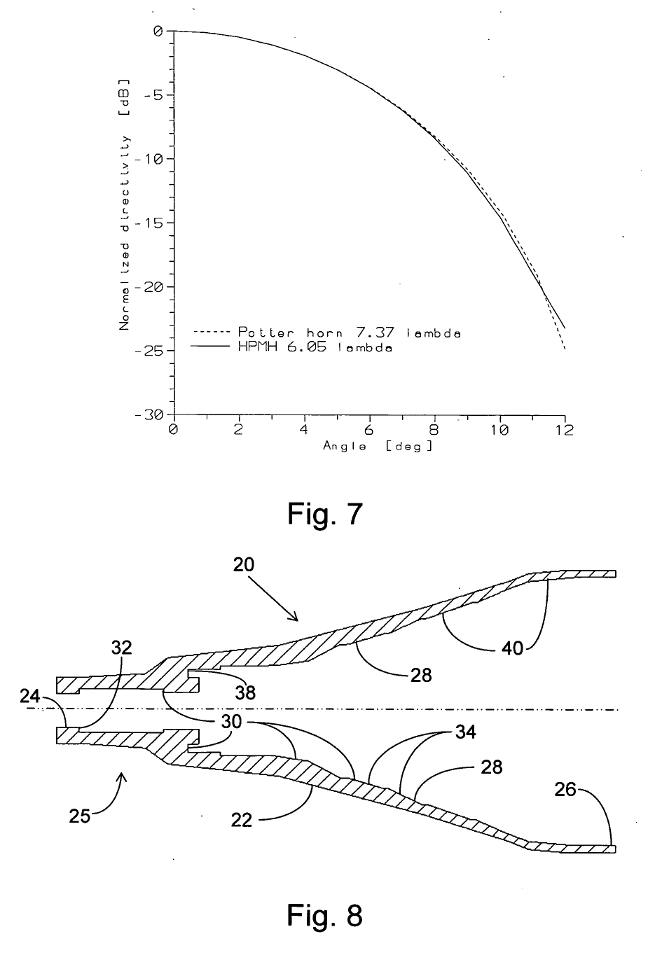

For example, the HPMH 20 shown in FIG. 8 has been developed for a Ka-band frequency application for which FIG. 3 provides a parametric performance analysis. An efficiency of 92% has been achieved over the 3% operating frequency band, hence allowing for an optimal MBA performance. FIG. 7 shows a comparison between the pattern of a 6.05-λ HPMH 20 (see FIG. 8) and that of a conventional 7.37-λ Potter (or dual-mode) horn 10 (see FIG. 4). As can be seen, the diameter of the Potter horn 10 providing the equivalent edge-taper would have to be 22% larger than that of the high-efficiency radiator horn 20. The horn 20a depicted in FIG. 9 has been developed for another Ka-band application where high-efficiency operation over the Tx (transmit) and Rx (receive) bands, at 20 GHz and 30 GHz respectively, was required.

The high-efficiency feed element 20 performance has been successfully verified by test measurements, as standalone units as well as in the array environment. The element design is also compatible with the generation of tracking pattern while preserving the high-efficiency operation for the communications signals.

Although conventional dual-mode 10 and corrugated 12 horns also rely on a mix of different modes, there are several fundamental differences between the conventional designs 10, 12 and the new HPMH 20. These differences are in the principles of operation used to achieve the proper structure of the horn 20. They are described herebelow and also summarized in following Table 1.

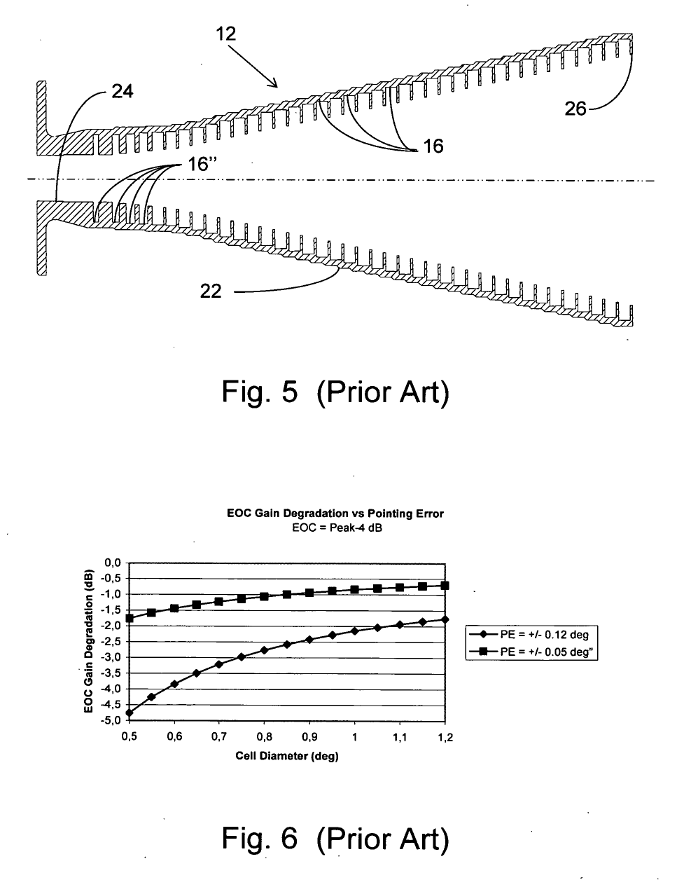

Dual-mode horns 10 as shown in FIG. 4 can achieve good pattern symmetry and cross-polar performance over a narrow bandwidth (typically no more than 10% of the operating frequency band). The primary design objective of a conventional corrugated horn 12 as shown in FIG. 5 is pattern symmetry and cross-polar performance over a much wider bandwidth or multiple separate bands. In order to achieve good cross-polar performance and pattern symmetry, both the dual-mode horn 10 and the corrugated horn 12 yield relatively low aperture efficiency. The HPMH 20, 20a, 20b of the present invention can be optimized to achieve any preferred (or desired) balance between competing aperture efficiency and cross-polar parameter requirements over either a narrow bandwidth, a wide bandwidth or multiple separate bands.

Dual-mode horns 10 typically offer higher aperture efficiency than corrugated horns 12, but over a much narrower bandwidth. In contrast, the present HPMH 20, 20a, 20b can achieve either equal or better aperture efficiency than the dual-mode horn 10 over the bandwidth of a corrugated horn 12 whenever required. In essence, the HPMH 20 combines—and further improves—desirable performance characteristics of the two conventional designs of horn 10, 12 in one.

The modal content of a dual-mode horn 10 is achieved only with steps 13 and smooth profiles 14 to change the horn flare angle 15. In conventional corrugated horns 12, the desired hybrid HE₁₁ (Hybrid Electric) mode is generated with a series of irregular corrugations 16″, and supported with a series of regular (constant depth and spacing) corrugations 16 only. The present HPMH 20, 20a, 20b, in comparison, uses any combination of regular/irregular corrugations 36, steps 32, chokes 38 and/or smooth profiles 34 to achieve the electrical performances of dual-mode 10 and corrugated 12 horns, in addition to others.

For multibeam antennas, all of the horns 20, 20a, 20b can be divided into a plurality of subgroups, with all horns 20, 20a, 20b of a same subgroup having the same discontinuities 30.

Depending on the specific application requirements (performance parameters), the depths and spacing of the corrugations 36 of the HPMH 20, 20b can be either regular or irregular, as needed. This differs from conventional corrugated horns 12, which have an irregular corrugation 16″ profile to generate, and a regular corrugation 16 profile to support the hybrid modes.

Dual-mode horns 10 only use two modes (dominant TE₁₁ and higher order TM₁₁ modes) to realize the desired radiating pattern characteristics. A corrugated horn 12 is designed to support the balanced hybrid HE₁₁ mode over a wide bandwidth. With the HPMH of the present invention, the whole structure 22 is used to generate the optimal modal content for a maximum antenna performance of a specific application. Unlike the corrugated horn 12, the optimal result is not necessarily a mix of balanced hybrid HE modes. The profile of the multimode horn 20, 20a, 20b, the geometry of the corrugations 36 and the aperture 26 can be optimized to achieve the performance improvement sought for each specific application.

Typically, the discontinuities 30 located adjacent the throat section 24 of the horn 20 are specifically designed to enable the simultaneous transmission and/or reception of the asymmetrical tracking modes and the higher order symmetrical modes of the communications signal. Some of the discontinuities 30, typically located in a matching section 25 of the horn 20, allow to match the horn impedance for the different symmetrical and asymmetrical modes.

Although the matching section 25 could be located anywhere between the throat section 24 and the horn aperture 26, it is typically located adjacent the throat section 24, as shown in FIGS. 8 to 10.

The high performance multimode horn can be designed for various frequency plans including, but not limited to, those described below:
Receive only communications signal(s) with Rx only tracking beacon signal(s).
Transmit only communications signal(s) with Rx only tracking beacon signal(s).

Transmit and receive communications signals with Rx only tracking beacon signal(s).

TABLE 1
Comparison of conventional and Improved
High Performance Multimode Horns

| | | | High Performance |
|---|---|---|---|
| | | | Multimode Horn for |
| | Dual-mode | | Communications |
| | Horn 10 | Corrugated Horn | and Tracking |
| | (ex: Potter) | 12 | 20, 20a, 20b |
| Modal | TE₁₁ and | Balanced hybrid | Multiple modes TE, |
| content | TM₁₁ | HE₁₁ mode | TM (not necessarily |
| | | | balanced hybrid); |
| | | | Tracking modes such |
| | | | as TM₀₁ and TE₂₁ |
| Discon- | Steps 13 and | Corrugations 16 | Corrugations 36 |
| tinuity | changes in | only (irregular | and/or changes in |
| 30 for | horn flare | corrugation 16″ | flare angle and/or |
| mode | angle 15 | profile to | steps 32 and/or |
| generation | | generate and | smooth profiles 34 |
| | | regular | and/or chokes 38 |
| | | corrugation | and/or dielectric |
| | | profile to | inserts (corrugations |
| | | support HE₁₁ | 36 can have |
| | | mode) | irregular profile.) |
| Design | Excellent | Excellent pattern | High aperture |
| objectives | pattern | symmetry and | efficiency, high |
| | symmetry and | cross-polar | reflector illumination |
| | cross-polar | performance | edge taper and |
| | performance | over wide | specified cross-polar |
| | over narrow | bandwidth or | performance and |
| | bandwidth | multiple separate | pattern symmetry |
| | | bands | over narrow or wide |
| | | | bandwidth or N |
| | | | separate bands; |
| | | | Efficient Propagation |
| | | | of asymmetrical |
| | | | tracking modes |
| Horn | Smooth | Corrugation 16 | Smooth flare angles |
| aperture | flare 15 | | and/or profiles 34 |
| 26 (output | | | and/or steps 32 |
| region, if | | | and/or chokes 38 |
| applicable) | | | |

Although the present high performance multimode horns for communications and tracking have been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

We claim:

1. A multimode horn for communications and tracking for transmitting and/or receiving an electromagnetic communications signal, said horn comprising a generally tapered wall flaring radially outwardly from a throat section to an aperture thereof, said wall defining an internal surface having a plurality of discontinuities, the geometry of said discontinuities being configured and sized for altering the higher order symmetrical mode content of the communications signal so as to achieve a balance between a plurality of performance parameters of the antenna over a pre-determined frequency range of the communications signal, said discontinuities matching an impedance of said horn for said communications signal and an asymmetrical mode content of a tracking signal simultaneously propagating therethrough.

2. The horn of claim 1, wherein the tracking signal is the communications signal.

3. The horn of claim 1, wherein the discontinuities for matching the horn impedance for the communications signal and the tracking signal are located within a matching section of said wall.

4. The horn of claim 3, wherein said matching section is located adjacent to the throat section.

5. The horn of claim 3, wherein said discontinuities of the matching section include a combination of different local smooth profiles, steps, corrugations, dielectric inserts and/or chokes.

6. The horn of claim 1, wherein said discontinuities are formed on said surface.

7. The horn of claim 3, wherein the geometry of said discontinuities of the matching section is configured and sized for allowing propagation of the asymmetrical tracking mode content and the symmetrical communication mode content within the pre-determined frequency range.

8. The horn of claim 7, wherein said asymmetrical tracking mode content includes at least one of TE₂₁ and TM₀₁ modes.

9. The horn of claim 1, wherein said discontinuities are generally axially symmetrical around a generally central axis of said wall.

10. The horn of claim 1, wherein said plurality of performance parameters includes tracking mode return loss and at least one of the group consisting of horn on-axis directivity, antenna illumination edge-taper, antenna illumination profile, and antenna spill-over losses.
